(19) United States
(12) Patent Application Publication
(10) Pub. No.: US 2026/0133427 A1
(43) Pub. Date: May 14, 2026

(54) Smart Glasses

(71) Applicant: Metaone Corporation, Taipei City (TW)

(72) Inventor: Kuo-Ching CHIANG, New Taipei City (TW)

(21) Appl. No.: 19/379,276

(22) Filed: Nov. 4, 2025

(30) Foreign Application Priority Data
Nov. 8, 2024 (TW) 113143276
Jan. 9, 2025 (TW) 114101125
Sep. 1, 2025 (TW) 114133635

(51) Int. Cl. G02B 27/01; B60K 35/23; G02B 27/00

(52) U.S. Cl. CPC G02B 27/0172; B60K 35/23; G02B 27/0093; G02B 2027/0178

(57) ABSTRACT

The present invention provides smart glasses comprising an image capturing device configurated in the smart glasses, a voice assistant is stored in a memory of the smart glasses to provide an assistant. An edge computing device configured in the smart glasses is coupled to the voice assistant to provide an AI analysis, wherein an image captured by the image capturing device or a result of the AI analysis is displayed on at least one glass of the smart glasses.

### TECHNICAL FIELD

The present invention relates to an AI device, more specifically, smart glasses.

### BACKGROUND

The popularity of smartphones and the internet has transformed people's lifestyles. With the advancement of the artificial intelligence, speech recognition technology has become increasingly sophisticated and widely used in many fields. Conversational AI can surpass traditional methods, allowing users to communicate with chatbot through text-based conversations and receive assistance from them.

However, most current applications focus on customer service or chatting service. The customer service applications utilize AI customer service to replace the traditional customer service personnel or chatbots. This invention proposes a new application area to create a brand-new service experience, as the application level needs to be expanded.

### SUMMARY OF THE INVENTION

To achieve the purposes of the present invention, in one aspect of the present invention, smart glasses comprises a communication device and an AI voice assistant disposed within the smart glasses. The smart glasses wirelessly connect to an AI computing device or AI server via the communication device to access a large language model. The smart glasses capture images by a camera and employ the AI model to perform image recognition, translation, or any combination thereof. After the camera captures the image, text in the image is recognized and captured, the text is translated into a second language by the AI voice assistant and displayed on the display or glass of the smart glasses. The AI voice assistant uses the communication device to perform online reservations, online shopping, and phone call answering, or any combination thereof.

In one aspect of the present invention, the present invention discloses a smart glasses comprising a camera configured on the smart glasses to facilitate image recognition; a communication device is configured on the smart glasses, wherein the communication device is wirelessly connected to an external AI computing device or AI server for connecting to the large language model; an AI voice assistant is stored in the memory of the smart glasses, and configured in the smart glasses, and the AI voice assistant performs the function of vocal consultation, translation or any combination thereof. The AI voice assistant, through processing by a processor, connects to the large language model through the communication device for consulting the large language model to seek answers. Preferably, the smart glasses comprises the camera configured on the smart glasses to capture images; the AI voice assistant is configured on the smart glasses to provide consultation and assistance to the user; and an edge computing device is configured in the smart glasses to provide AI analysis to facilitate image recognition or consultation analysis. In one case, the AI assistant is software driven by artificial intelligence that understands natural language, process instructions, and perform specific tasks to assist the user.

In one aspect, the smart glasses include multiple sensors to sense surrounding environment or commands generated the user's posture and gestures, followed by analyzing them by using the processor and/or AI model, and displaying the results on the glass or notifying the user via a speaker or by bone conduction mechanism. The sensors include an inertial sensor, GPS, magnetometer or any combination thereof; the inertial sensor is selected from an accelerometer, a gyroscope or any combination thereof; the smart glasses include an eye detection light source disposed therein.

In one aspect, the present invention remotely updates the AI model for the voice assistant or the smart glasses from external terminal or server. In one embodiment, the smart glasses include an antenna configured on a frame. In one aspect, the smart glasses include the edge computing device, and the image is recognized by the edge computing device, or the smart glasses recognize the image through a mobile phone or a cloud server. In one embodiment, the smart glasses include the AI model, an AI processing unit or the combination thereof. The smart glasses are paired with a vehicle to display driving information, directions, or augmented reality; the smart glasses are coupled to the smartphone to display information on at least one glass of the smart glasses, the information includes a song title, artist (singer) name, lyrics, phone number, contact name, nickname, contact ID, contact image or any combination thereof.

### BRIEF DESCRIPTION OF THE DRAWINGS

FIG. 1 and FIG. 1A show schematic diagrams of the present invention.

FIG. 2 shows a functional block diagram of a generative cloud device according to the present invention.

FIG. 3 shows a functional block diagram of an AI device according to the present invention.

FIG. 3A shows a functional block diagram of an AI device according to the present invention.

FIG. 3B shows a functional block diagram of a video generator according to the present invention.

FIG. 4 shows a functional block diagram of an AI device according to the present invention.

FIG. 4A shows a functional block diagram of the present invention.

FIG. 5 shows a schematic diagram of smart glasses according to the present invention.

FIG. 6 shows a functional block diagram of a phased array antenna according to the present invention.

FIG. 7 shows a schematic diagram of smart glasses according to the present invention.

### DETAILED DESCRIPTION

The present invention will be described in detail herein with respect to specific embodiments and aspects of the invention. This description is intended to explain the structure or process flow of the invention and is for illustrative purposes only and is not intended to limit the scope of the claims. Therefore, in addition to the specific embodiments and preferred embodiments described herein, the present invention may be implemented in a wide variety of other embodiments. The following describes the implementation of the present invention using specific embodiments. Those skilled in the art will readily understand the effectiveness and advantages of the present invention through the disclosures herein. Furthermore, the present invention may be applied and implemented through other embodiments, and the details described herein may be adapted to meet different needs and modified or altered in various ways without departing from the spirit of the invention. A module, as used herein, refers to a specific functional component composed of several basic functional elements that can be used to form a fully functional system, device, firmware, software, instructions, or program. Modules typically share a common process or logic, and their components can be modified to adjust their functionality or use. Modules can be hardware, software, or firmware.

The generative artificial intelligence (AI) technology mimics human decision-making processes, learns human language or any complex subject in non-traditional computing tasks. The generative AI uses training data to solve problems for a variety of purposes. The generative AI uses machine learning models, which are very large models pre-trained based on a large amount of data. Large language models (LLMs) are basic type models. For example, OpenAI's Generative Pre-Trained Transformer (GPT) model is an LLM. LLMs specialize in language-based tasks such as summarization, text generation, classification, open-ended conversation, and information extraction. LLMs contain many parameters, enabling them to learn advanced concepts. LLMs like GPT-3 can consider billions of parameters and are able to generate content based on very small amounts of input.

The generative AI uses text as its primary interaction method, such as ChatGPT. OpenAI has published a general speech recognition model that can transmit information to the Whisper API and return speech recognition results, supporting conversion between speech and text, as well as translation. The present invention proposes a smart device based on the generative AI that can apply AI services to search engines and social apps. Machine learning models are discriminative; for example, these models examine images, known data such as pixel arrangements, lines, colors, and shape, and map them to words. Generative models take this a step further, predicting features given specific labels. Generative adversarial networks (GANs) are another generative AI model based on the concept of diffusion models. GANs operate by training two neural networks in a competitive manner. The first network, called the generator, generates fake data samples by adding random noise. The second network, called the discriminator, attempts to distinguish between real data and fake data produced by the generator. The GPT model has become a foundational model, capable of being pre-trained on a wide range of raw text corpora and fine-tuned for different tasks. During training, the generator continuously improves its ability to create realistic data, while the discriminator increasingly strengthens its ability to distinguish between real and fake data. This adversarial process continues until the generator produces convincing data.

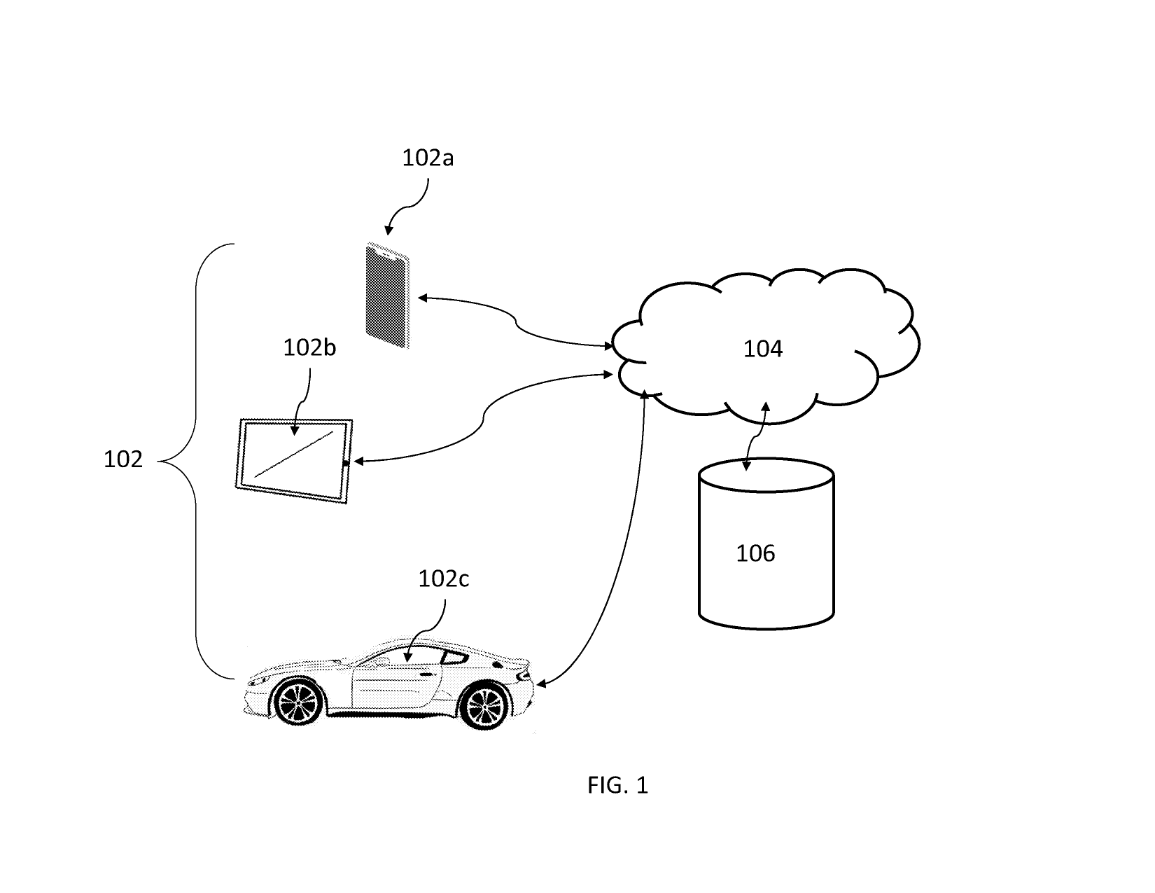

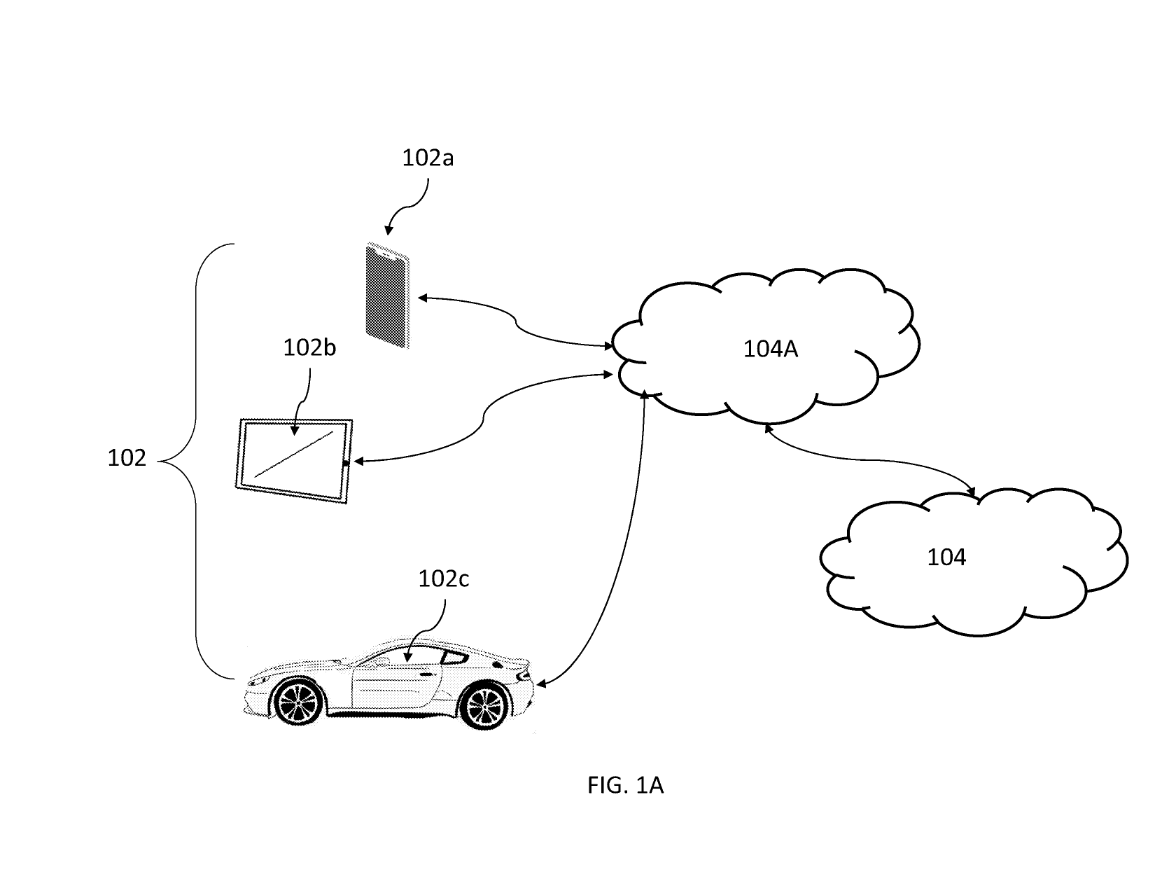

FIG.1 shows the system architecture of the present invention, including a user- generative AI computing device 102, a generative cloud device (or a generative AI chatbot, cloud server) 104, and a generative database 106. The AI computing device 102 includes a smartphone, an AI phone, etc. The terms smartphone and the AI phone are used interchangeably in this application. The AI phone is a smartphone equipped with artificial intelligence (AI) technology. It features a built-in AI chip and computing capabilities that can learn user habits and provide features such as intelligent photography, natural vocal conversation, real-time translation, article summarization, and system optimization. The AI phone of the present invention is able to execute generative AI applications directly on the device, which is different from ordinary smartphones that used to rely mainly on cloud computing. The generative cloud device 104, for example, is a generative AI voice chatbot, which is a conversational platform built on a quasi-neural system and natural language processing technology (NLP). The generative cloud device (generative AI robot) 104 can be applied to searching engines (applications), such as Google, Bing, electronic map applications, navigation software, chat apps, and social apps to establish an automated service platform. The AI computing device 102 of the present invention cooperates with a precise positioning device to generate results related to geographic location dependencies.

The generative apps are implanted or built into the generative AI computing device 102, such as generative searching engines (applications), generative navigation software, generative chat apps, and generative social apps. For example, Microsoft has integrated ChatGPT into the Bing browser, allowing users to query information by asking questions. The Microsoft Bing browser integrates the language module of ChatGPT, provides a conversational search method, and displays organized content services in organized articles. Similarly, the navigation software, the chat apps, and the social apps integrates the language module of ChatGPT to achieve generative navigation software, generative chat apps, and generative social apps. However, the disadvantage of the Bing browser is that it only responds to the content entered by the user, does not provide relevant responses to the user's geographic information, and does not have a generative image searching function.

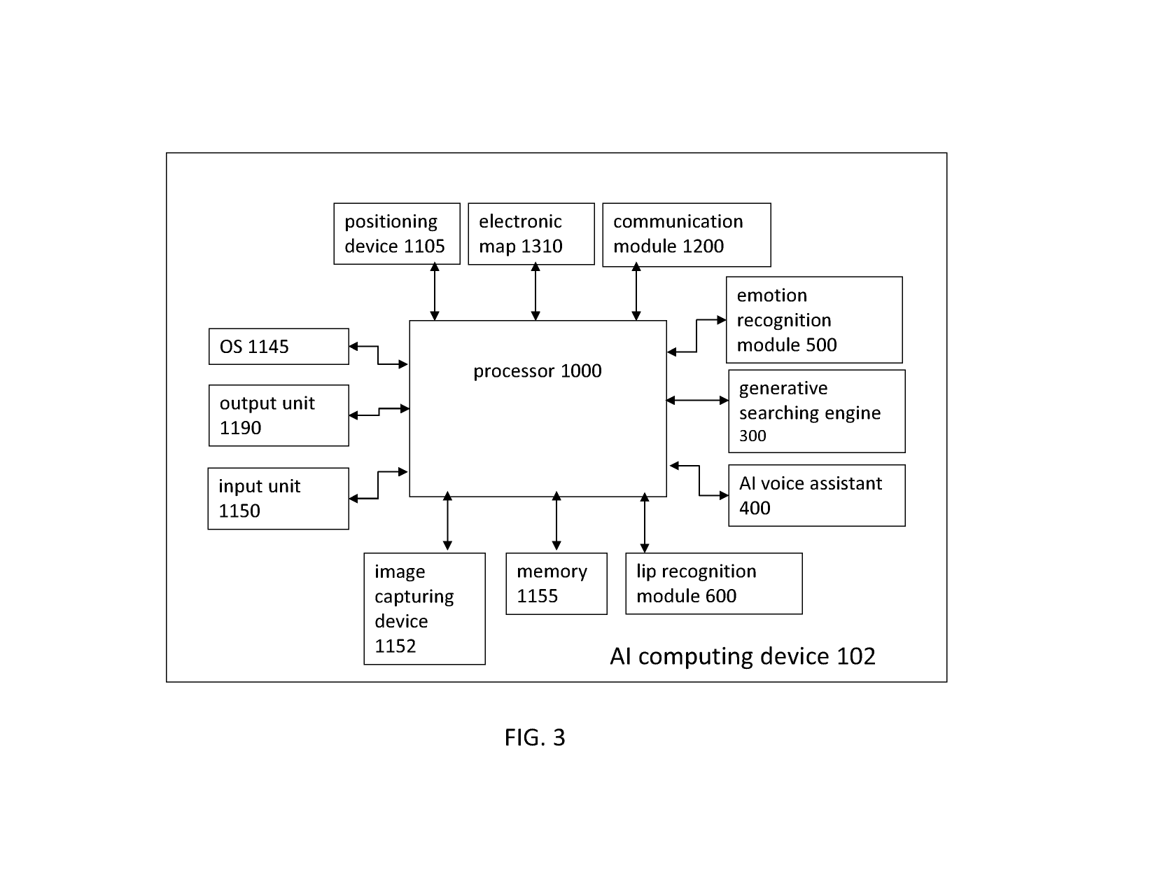

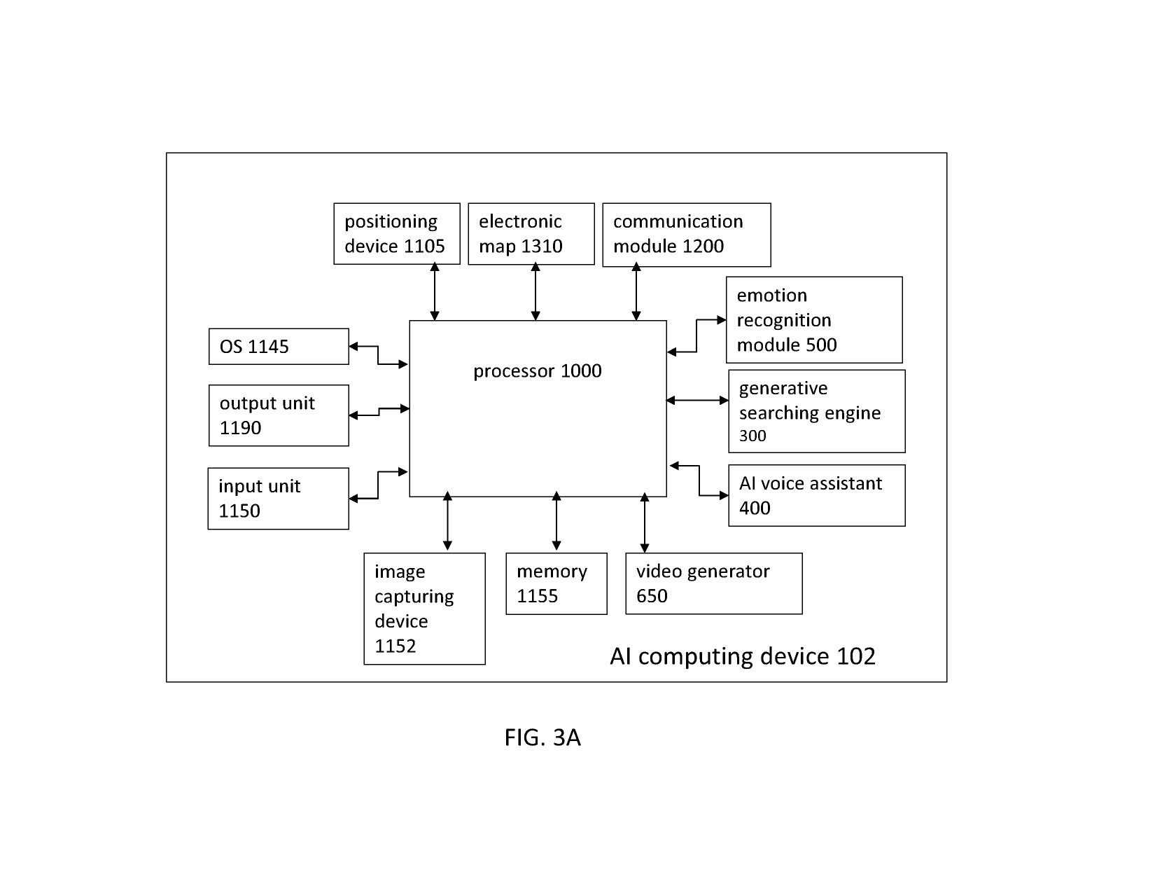

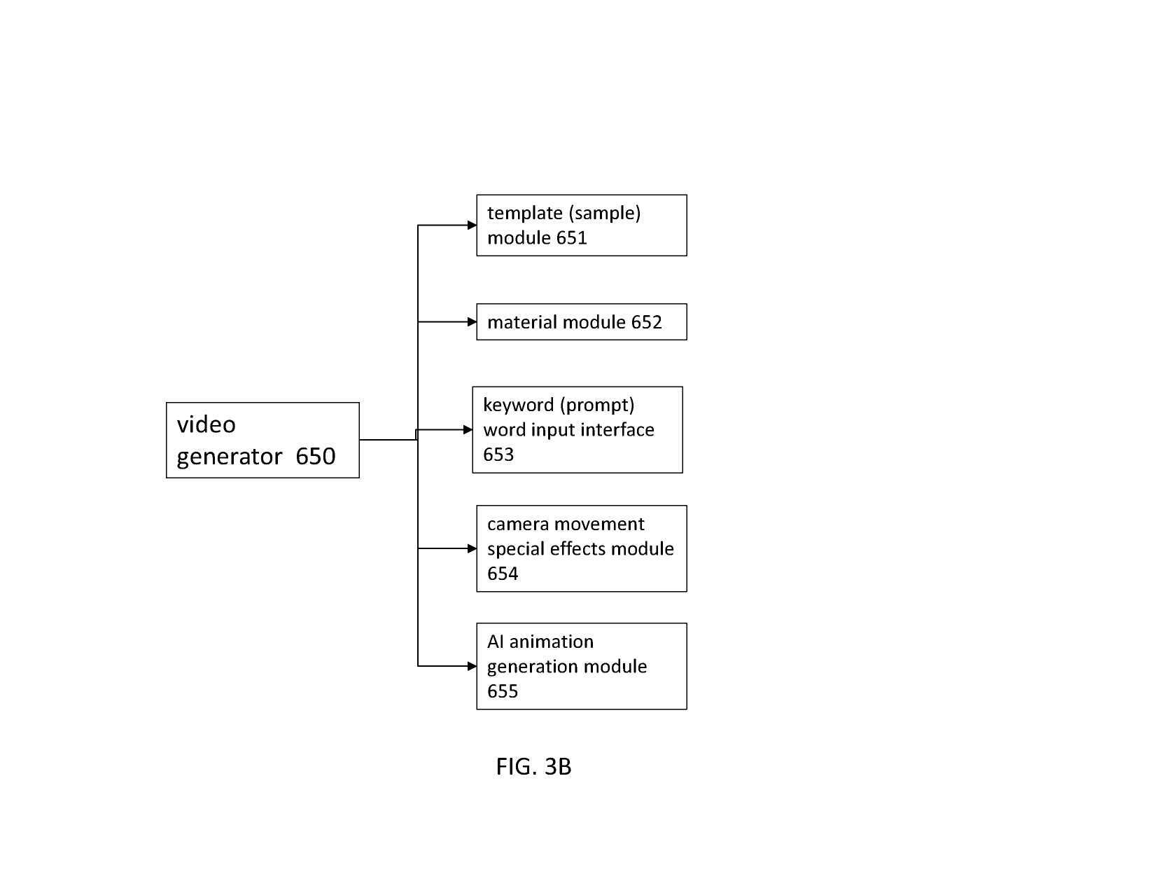

In one embodiment of the present invention, features related to the geographic information are introduced to provide more accurate response content. FIG. 3 uses a generative searching engine 305 of a browser as an example for the generative APP, such as the generative navigation software, the generative chat APP, and the generative social APP, which can also be applied to the following embodiments. To facilitate the description of the advantages and features of the embodiment, the following will use the generative searching engine (or browser) 305 as an example. The generative AI model uses GPU computing power and a large amount of data to self-generate data and information hidden in the data. The reinforcement learning mechanism is introduced in the generative AI training process to help and guide the model to quickly converge in the correct and applicable direction. This artificial intelligence can create and generate natural language, music, images, and other forms of data.

The generative cloud device (or generative AI chatbot) 104 can be a server in a cloud architecture. The user's AI computing device 102 can communicate with the generative cloud device 104 via a communication network to send and receive relevant information. The generative cloud device 104 includes a Whisper API with automatic speech recognition (ASR) capabilities and a ChatGPT API based on a large language model, which can communicate with the generative cloud device 104 via the internet.

In another embodiment, as shown in FIG. 1A, data is transmitted to a distributed model, and some computations are performed at the edge of the network. The edge computing deployment improves efficiency or confidentiality and shortens the distance between data generation and data processing, analysis, and storage, achieving near-instant analysis and response speeds. The edge computing does not involve cloud computing, which can protect private sensitive data, reduce the amount of data transmitted on the network, and help reduce the risk of interception and improve security. 5G and 6G modules provide high-bandwidth, low-latency connections for fast data transmission and service provision from the edge. The edge computing device 104A has a built-in AI processor that provides analysis or advanced AI functions. The edge computing device 104A processes the data and then send back the information required by the application, or only send the relevant part of the data to the cloud. Data from multiple edge computing devices 104A can be integrated in the cloud for more extensive processing and analysis. The edge computation in 5G and 6G networks implements virtualized telecom core network (vEPC) technology. In one embodiment, the edge computing device 104A is directly built into the AI computing device 102, such as a generative AI mobile phone 102a, a generative AI tablet (laptop or computer) 102b, a generative AI transportation vehicle 102c, or generative AI smart glasses 300.

In one embodiment, the AI computing device 102 is selected from the AI mobile phone (or smartphone) 102a, the AI tablet (AI laptop or AI computer) 102b, the vehicle 102c, or the smart glasses 300. According to an embodiment of the present invention, a generative app of the AI computing device 102, such as a generative searching engine 300, can receive voice and/or text input and provide feedback results. For example, a specific dialogue response is a reply to the user’s input obtained through the generative AI cloud device 104 (or edge computing device 104A). According to one embodiment of the present invention, the communication network may include, but not limited to, a LAN network, a WAN network, and the Internet network. According to one embodiment of the present invention, the communication network may be implemented using, for example, a Wi-Fi network, GSM, CDMA, TDMA, Bluetooth, VoIP, Wi-MAX, Wibro, or any other wireless communication protocol, such as a low-orbit satellite communication network.

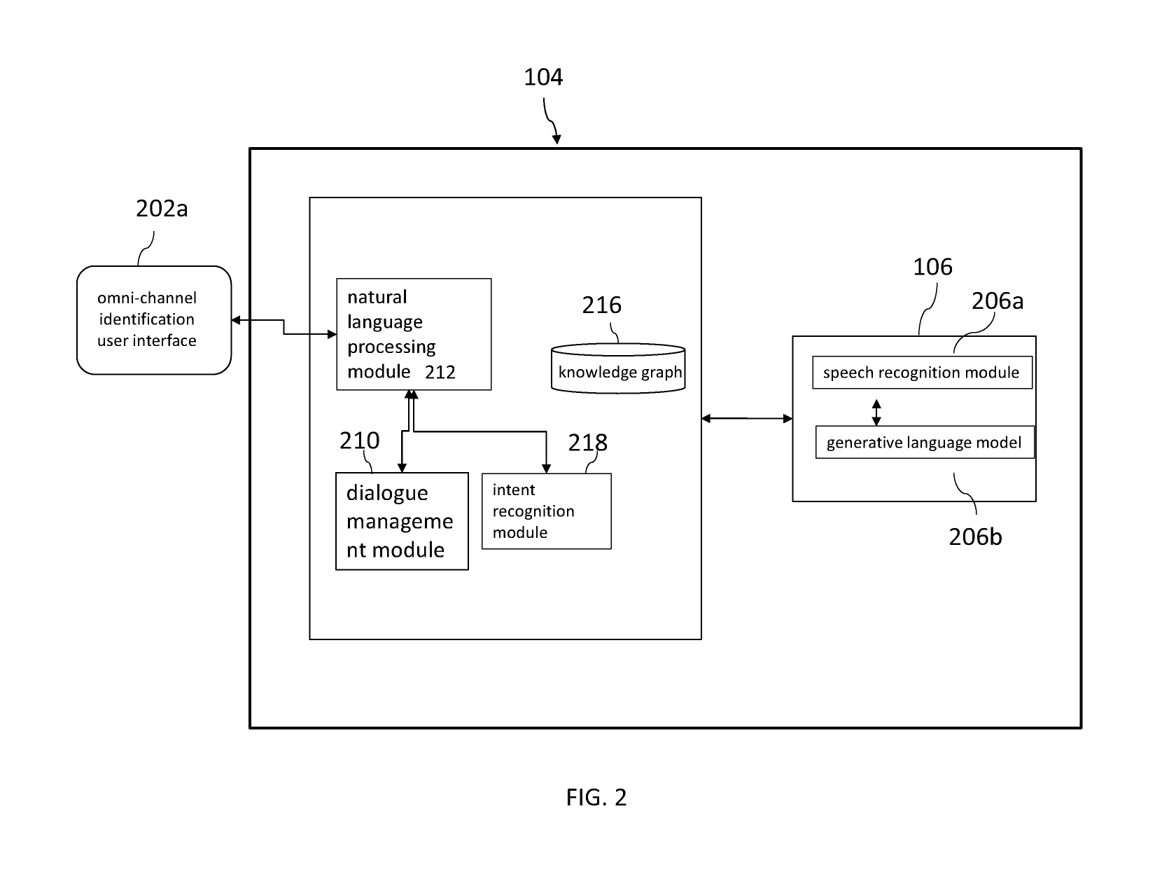

According to one embodiment, referring to FIG. 2, the generative AI cloud device 104 (or edge computing device 104A) includes at least a dialogue management module 210, a natural language processing module 212, a knowledge graph 216, and an intent recognition module 218. The natural language processing module 212 is used to receive sentences or text input by the user, and process the sentences or text by algorithm. The dialogue management module 210 generates a series of corresponding processes based on the user intent determined by the natural language processing module 212. The knowledge graph 216 is a knowledge base in which the data is integrated by a graph-structured data model or topology. The knowledge graph 216 is used to store knowledge related to intelligent message replies. The intent recognition module 218 classifies the intent of the user's question, determines the intent category in the user's question, and the prediction results of each category.

The generative cloud device 104 has a generative database 106, which includes a speech recognition module 206a and a generative language model 206b. An omni-channel identification user interface 202a is used to receive user voice or text inquiries, such as through a searching engine or a social application. The user's inquiry content (text or speech) is input into the generative database 106 via the generative cloud device 104. If the input inquiry content is in speech format, the speech recognition module 206a, such as the Whisper speech recognition module, automatically generates the inquiry content. The language model ChatGPT is then cooperated with the knowledge graph module to generate a relevant reply for the user. If the inquiry content is in text format, the generative language model 206b, such as ChatGPT, is directly cooperated with the knowledge graph module to generate a relevant reply. According to an embodiment of the present invention, equipped with a fuzzy engine and utilizing GPT-3.x, GPT-4.x, and subsequent versions, it can accurately understand the meaning of words in context and recommend the correct prompt word. In one embodiment, the generative cloud device 104 is a conversational AI platform developed based on a quasi-neural system and natural language processing (NLP) technology. Large language models include, but are not limited to, ChatGPT, Gemini, LLaMA, Grok, and Claude.

FIG. 3 shows a generative searching engine 305 embedded in the AI computing device 102. A user submits a request to the generative cloud device 104. For example, the request may be for searching EV charging stations, gas stations, stores, hotels, restaurants, famous attractions, or cultural information within a geographic area. The request may also be for real-time weather information, travel information, and traffic information. By using browser as an example, initially, the user submits a request through the user interface of the browser, such as Bing or Google. If such a request involves the geographic area, the generative cloud device 104 obtains the geographic location of the AI computing device 102 from the AI computing device 102 by requesting or user’s pre-setting.

The AI computing device 102 shown in FIG. 3 includes a processor 1000 and a positioning device 1105, including but not limited to, a GPS, a gyroscope, an accelerometer, or a low-orbit satellite positioning device, coupled to the processor 1000. Conventional satellite positioning devices and low-orbit satellite positioning devices include a receiver for signal processing and decoding. The present invention includes an input unit 1150, an operating system 1145, and an image capturing unit 1152. An electronic map 1310 is stored in a memory 1155, which is coupled to the processor 1000. A communication module 1200 is coupled to the processor 1000. The communication module 1200 is selected from a wireless local area network device (e.g., Wi-Fi), a mobile phone communication module (e.g., a WCDMA module), etc., and is electrically coupled to the processor 1000. The communication module 1200 can be used to download or update data, such as the generative searching engine 300 or the electronic map 1310. The communication module 1200 is used to receive real-time information, such as real-time weather, travel, or traffic information. Based on 5G, 6G or higher versions, the communication module 1200 transmits image information, thereby receiving real-time image information. Therefore, while the vehicle or individual is moving, the communication module 1200 is connected to the generative cloud device 104 to receive the required information at any time. The input unit 1150 (such as a touch panel, microphone, physical keys) and the output unit 1190 (such as a display, speaker) are individually coupled to the processor 1000 to allow command input or signal output.

In one embodiment, the generative cloud device 104, automatically or by default, obtains the location information of the AI computing device 102. Without user’s confirmation (or with user’s confirmation), the generative cloud device 104 determines the location and provides the user with more accurate content related to the geographic information. When connecting to the Internet, based on the geographic information of the current user device, the generative cloud device 104 generates information related to the geographic area, which can be used for guided tours, descriptions, and navigations based on the geographic information. In particular, it can automatically generate guided tour content related to the geographic information, including descriptions of humanities, geography, customs, crafts, food, culture, history, people, art, architecture, etc., the above features replace the functions of real tour guide and tour guides, thereby providing comprehensive and multiple aspects contents. In one embodiment, the edge computing device 104A can replace the generative cloud device 104. The above features are applied to form the generative the weather app, the generative EV charging station map app, the generative restaurant map app, and the generative humanities guiding apps etc.

The memory 1155 is coupled to the processor 1000 and serves as a data and operating system storage. Depending on its properties, it may include read-only memory, random access memory, non-volatile flash memory, etc. The communication module 1200, such as a RF communication module (a mobile phone is a type of radio frequency communication), can handle signal reception, encoding/decoding, baseband processing, etc. The signal is sent to the output unit 1190, such as a speaker or display. The antenna system is used to transmit or receive signals. The latitude and longitude information obtained by the satellite positioning system can be imported into the positioning device 1105. It cooperates with Wi-Fi signals and inertial devices, such as gyroscopes or accelerometers, to generate a precise geographic location through algorithms.

The communication module 1200 is coupled (connected) to the processor 1000, and the communication module 1200 includes a mobile communication device, a Wi-Fi device, a Bluetooth device or any combination thereof. The answer obtained by the generative searching engine 305 is shared with other contacts or friends in the social application by transmitting or receiving voice, image signals or both through the communication module 1200, so that the present invention can synchronously share generative information wirelessly. The smart image searching introduces object recognition into the image, making each picture readable. This function can identify buildings and landmarks in the user's photo or image searching. The conversational searching enhances the searching suggestion/auto-completion functions. The present invention provides query optimization suggestions to the user based on the user's initial query and provides the best answer to the user. The generative APP of the present invention uses the smart searching function to provide smart answers, smart image searching and conversational searching results. The generative searching engine 300 is supported by the large language model (LLM), such as GPT-4, for data collation, and synthesize them into human-like responses that exhibit human-like understanding, contextual relevance, and conversational skills.

After the generative cloud device 104 responds, the generative searching engine 305 delivers relevant advertisements to the user based on the query content, the reply content, the geographic information or any combination thereof. This feature of advertisement delivery can also be applied to the generative navigation software, generative chat apps, generative social apps, generative weather apps, generative EV charging station map apps, generative restaurant map apps, generative cultural guide apps, etc. In another embodiment, in the advertising delivery application, it is not necessary to provide geographic information because the product may not be directly related to the geographic information. This advertising delivery feature can also be applied to generative apps that are not related to geographic location. The key to delivery lies in the content of the user's query. The generative chat app or server extracts feature keywords based on the query content and delivers the relevant advertisement to the user. The method or embodiment proposed by the present invention is executed in a server or similar computer system. The server/computer system generally includes at least one controller, and the peripheral devices may include a storage system, such as memory and file storage, a user output interface device, a user input interface device, and a network interface. The network interface provides the connection to an external network and is coupled to corresponding interface devices of other computing devices. User input devices may include a keyboard, mouse, trackball, touchpad or pointing device, touch screen integrated into the display, microphone, and other types of input devices. The computing device may be of various types, including a workstation, server, computing cluster, or other data processing system or computing device.

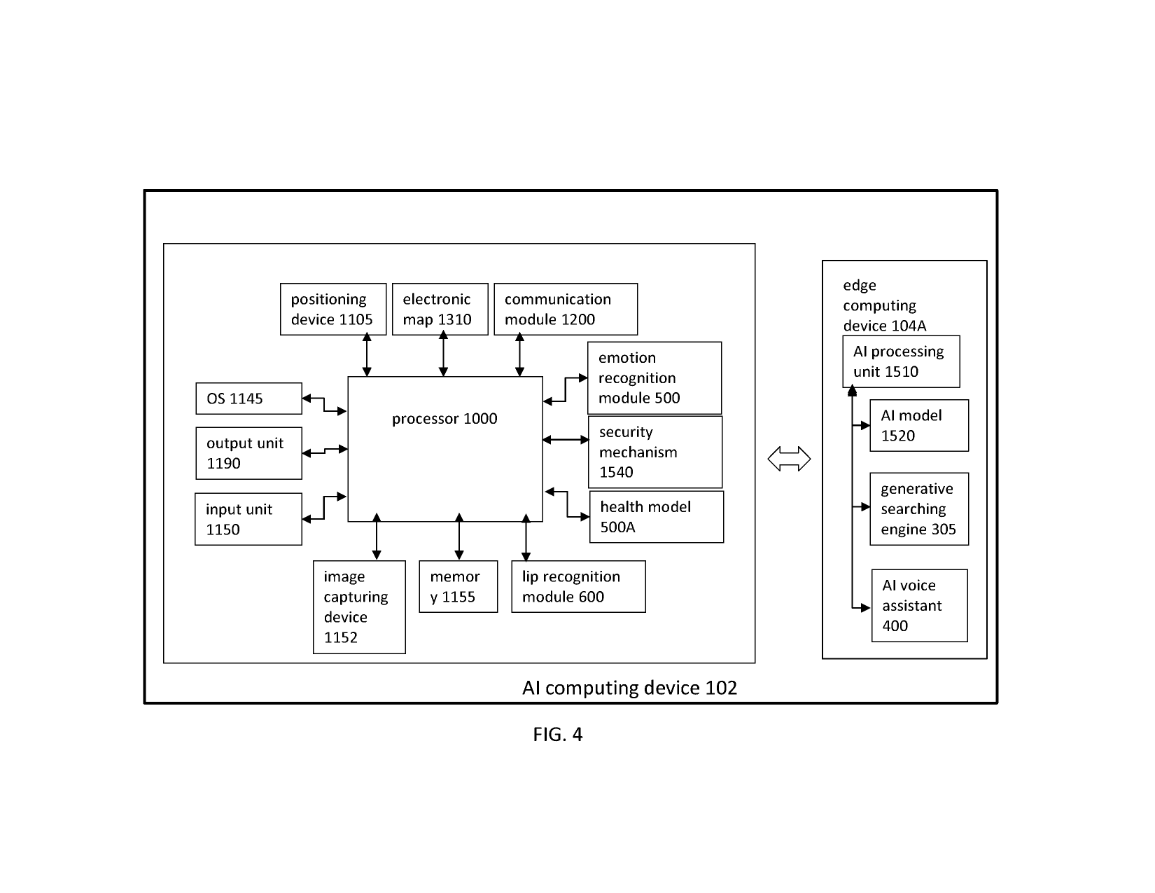

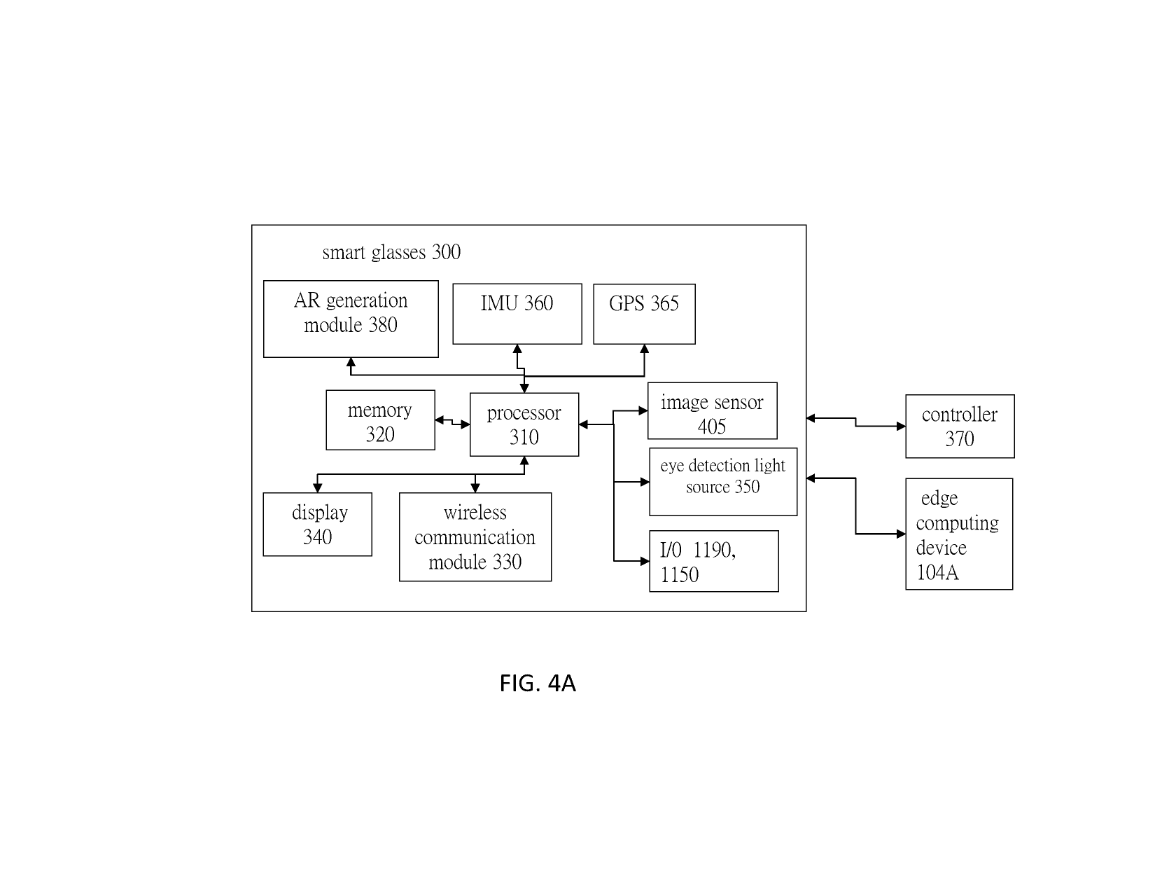

Advanced voice assistants, such as Google Assistant and Siri, can perform daily tasks, set reminders, answer questions, and convert speech to text, thereby improving the speed and accuracy of information input. The AI computing device 102, such as the AI mobile phone 102a, includes an advanced artificial intelligence smartphone. Since it is necessary to process AI models, the present invention has a built-in GPU or NPU. For example, in addition to the CPU, the processor 1000 may also have GPU, TPU, and NPU (Neural-network Processing Unit) or any combination thereof. The NPU is used to accelerate the processor of AI mobile phone applications. Unlike the CPU or GPU, it processes neural network models with low energy consumption for AI computing tasks. Referring to FIGS. 3 and 4, the AI computing device 102 is equipped with a generative AI voice assistant 400 to conduct complex conversations and task processing and understand more natural language. The generative AI voice assistant 400 includes software, firmware, or instructions stored in the memory 1155. In the AI computing device 102, the NPU typically works in conjunction with the CPU and GPU to form a multi-core architecture of "CPU+GPU+NPU", providing more efficient computing power and energy efficiency, enabling the AI computing device 102 to more effectively execute complex AI functions and tasks. The generative AI voice assistant 400 learns user preferences and automatically adjusts settings such as brightness, sound, tone, etc., and recommends content (e.g., music, videos) and applications.

In one embodiment, by training with the generative model, the generative AI voice assistant 400 learns the user's voice, intonation, and fetches voiceprint for acting as a user virtual agent, virtual answering machine, virtual secretary, or virtual receptionist. When the user is unwilling or inconvenient to answer the phone, the generative AI voice assistant 400 answers the call on one’s behalf, for example, responding to the caller (or chatting with them), or making a call, making a reservation for the user. Alternatively, when the user is unable to answer, the generative AI voice assistant 400 answers the call and records the content. In one embodiment, the AI voice assistant 400 can be configured with a preferred voice and intonation. Through training with the generative model, the AI voice assistant 400 learns the user's voice, intonation, and voiceprint to act as the virtual agent. For example, voices of such as Mickey Mouse and Iron Man can be configured. ChatGPT's voice and image capabilities can be used to train AI for voice conversations. The voice function of the AI voice assistant 400 utilizes a text-to-speech model, which generates near-human speech from just a few seconds of speech. To transcribe the user's speech into text, the open-source speech recognition system Whisper maybe used.

The following technologies can be used for intelligent audio recognition and voiceprint recognition: (1) Speech recognition software, such as Google Speech Recognition, Microsoft Speech API, etc. These tools convert audio into text. (2) Speech analysis tools, such as Praat, Audacity, etc., perform audio processing and analysis, such as spectrum analysis, fundamental frequency analysis, etc., which is used for voiceprint recognition. (3) Machine learning algorithms: deep learning models, etc. These algorithms are used to train voiceprint recognition models. Tools for intelligent audio recognition and voiceprint recognition include: Google Cloud Speech-to-Text API, which can convert audio into text and provide high-quality speech-to-text capabilities. Amazon Transcribe automatic speech recognition service, which can convert audio files into text. VoiceIt voiceprint recognition service, which is used to verify the identity of the user, can recognize the user's voice, and thus determine the user's identity after comparison.

The AI computing device 102, such as the AI mobile phone 102a, has powerful computing capabilities. Another feature of the AI computing device 102 is that it can perform AI computing directly on the AI mobile phone 102a even offline. The AI voice assistant 400 incorporates a "speech-to-text" function into the recording function, which converts the recorded speech into a transcript, and compiles a meeting summary and translation through intelligent analysis.

The AI voice assistant 400 searches for the contact information of restaurants and hospitals for reservation online through the generative searching engine 305 based on the user voice control, such as making a call for reservation through the AI voice assistant 400 by voice or text. The above-mentioned AI voice assistant 400 can also be embedded or built into the AI tablet 102b, transportation vehicle 102c, and smart glasses 300. When embedded in the transportation vehicle 102c, it serves as a virtual co-pilot or companion, chatting with the user to relieve boredom, and perform all the above functions. When the AI voice assistant 400 encounters information that it cannot process, it can send a request message to the generative language model 206b, such as ChatGPT, in conjunction with the knowledge graph module, to generate relevant replies, conduct a dialogue with the other party, and perform the agent (proxy) task. After the AI voice assistant 400 completes the tasks, the generative language model 206b, such as ChatGPT, and the generative cloud device 104 can be configured to automatically delete the requested question and the related answers to facilitate privacy protection. In one embodiment, the edge computing device 104A replaces the generative cloud device 104. Although the embodiment is described using the AI mobile phone 102a, it can be also applied to the AI tablet 102b, the transportation vehicle (vehicle) 102c, and the smart glasses 300. In summary, the above-mentioned AI voice assistant 400 with generative capabilities performs multiple rounds of dialogue to facilitate the execution of agent tasks, such as online reservations, online shopping, image searching, voice navigation, weather forecasts, gas station guidance, charging station guidance, traffic sign reminders, or any combination thereof. The above-mentioned generative language model 206b, such as ChatGPT, is built into the AI computing device 102.

Referring to FIG. 3, the present invention includes an emotion recognition module 500 to extract the emotion feature for analyzing emotion. The generative AI computing device 102 selects music that is appropriate for the user's current mood based on the emotion-corresponding music already established in the emotion-corresponding music database. The emotion-corresponding music database is established in the cloud or on the user's end, and it includes music classification and emotion classification to facilitate matching music with the user's emotions. The music is then played through a music playing app or streaming app. Facial big data analysis can be performed through the aforesaid generative model training to collect a plurality of expression features for generating training results. The emotion recognition module 500 is used to identify the captured emotion features through the processor 1000. In one embodiment, the emotion recognition module 500 can be an independent application or command, or embedded in a music playing app. The aforesaid music playing program or app can be downloaded via the Internet or the cloud. The music playing app includes a music database stored in the cloud. The music can be downloaded and stored in the AI computing device 102 via the music playing program or app.

In one embodiment, the emotion recognition is implemented using Deepface, a Python face recognition and facial attribute analysis (age, gender, emotion, and race) software. Deepface is a hybrid of advanced face recognition models that includes: VGG-Face, Google FaceNet, OpenFace, Facebook DeepFace, DeepID, ArcFace, and DlibSFace. Deepface is completely open-source code and can be applied and modified in personal and commercial environments. In conjunction with the Deepface library, after detecting a face, the emotional response of the face (joy, anger, sadness, etc.) is instantly identified, and the age of the face is estimated (even the gender and race of the face can be detected). Therefore, the built-in emotion recognition module 500 of the present invention can also be used to identify age, which is convenient for restrictive transaction authentication or age verification, such as purchasing cigarettes, alcohol, and restricted goods. It can also be used as age verification for logging into restricted websites and age-restricted vending machines. Developed by the Facebook AI research group, the DeepFace library is a comprehensive and easy-to-use facial recognition and feature analysis library. DeepFace was developed using TensorFlow and Keras with Python. The emotion recognition module 500 analyzes parameters including emotion, age, gender, and race. If the emotion recognition module 500 is integrated into consumer devices (such as mobile phones, computers, televisions, tablets, vending machines, and mirrors) to identify the user's age, it could replace parental locks. In this case, the emotion recognition module 500 could be called an age recognition module. In the embodiment, the consumer device certainly includes many parts or all of the configurations and devices shown in FIG. 3, such as image capture, processor, etc.

In one embodiment, the emotion signal is captured by the image capturing device 1152. The image capturing device1152 can be a photographic device, a camera, etc. The AI computing device 102 is connected to a system via the Internet, for example, online shopping system, unmanned store system, karaoke device, online store, music streaming system, or (online) music playback system. The above connection is achieved through currently known connection technologies and/or the use of an app. Biometric features such as facial and eye images or features can be captured by the image capture device 1152, while voice biometric features are collected via the microphone. These voice biometric features can be stored in the AI computing device 102. The emotion recognition module 500 is executed by the processor 1000 to identify the captured emotional features and output an emotional analysis result. After the biometric samples are captured or collected, the biometric features can be stored in the generative (AI) computing device 102. Subsequently, the user's emotional features are detected, captured, and analyzed to generate an emotional feature (expression) image of the user; the emotional feature analysis is performed using the emotion recognition module 500. The above-mentioned emotional data can also be obtained by capturing facial or brainwave information, for example, analyzing the emotions expressed on the face. The emotional characteristics and/or the emotional analysis results are transmitted to the above system, and based on the emotional characteristics and/or the emotional analysis results, corresponding products are recommended. In this step, according to the analyzed user emotional characteristic data, for example, the facial emotions are identified to facilitate the identification of the user's emotions. After identification, the user's emotional expression attributes are determined, such as anger, contempt, disgust, happiness, smile, laughter, sadness, surprise, etc. The corresponding products are recommended based on the emotional characteristics; subsequent steps, such as storing the products corresponding to the user's emotional characteristics in the AI computing device 102 or the generative cloud device 104, are used to facilitate data collection and big data analysis.

The present invention uses a large data database of emotions and recommends corresponding products (for example, music) to provide a better and more convenient communication interface. Therefore, the recommend products, such as music, can be automatically transmitted to the user based on their emotional characteristics via the emotion feature capturing device. The present invention provides convenient interfaces for obtaining recommended products (e.g., videos, books, or music) and the facilities can be applied to systems such as unmanned stores, online stores, music streaming systems, video streaming systems, smart speakers, car audio systems, karaoke devices, augmented reality devices, and virtual reality devices. Additionally, when the application is activated, the biometric capturing module automatically captures the user's biometrics, allowing to access the application after verification. Furthermore, the biometric sample may be updated with new captured biometrics. The image capturing device 1152 captures the image (feature) of the user's facial features. The image capturing device 1152 includes an image sensor, and the image of the user's facial features can be stored in memory 1155. After activating emotion recognition module 500, AI computing device 102 analyzes the user's emotions to determine the user's emotional classification. In one embodiment, the emotion recognition module 500 is used to determine the user's emotion. The user's emotional parameters, indicators, or facial expressions is displayed on the display; the emotional facial expressions are generated by the emotion recognition module. After the user's emotions are analyzed, the emotional characteristics are transmitted to a music playback program or app installed on the user device 102 or a remote device. Based on the emotional characteristics, the music corresponding to the analyzed emotion category is played. For example, the music corresponding to the emotion is automatically selected from the music database or the AI computing device 102. The music and emotion categories are stored in the cloud or AI computing device 102. For example, the music playing program or app includes these categories, allowing the program or app to match music based on the user's mood. In other words, a specific emotion is associated with a corresponding music category. In one embodiment, after analyzing the user's facial emotions, corresponding products are recommended based on the analyzed emotion category. Multiple expression features are collected and facial big data analysis is performed by the aforesaid generative model training to generate training results. The embodiment can also be applied to lip reading recognition. In other words, the image capturing device 1152 captures the user's lip shape. The generative AI computing device 102 or the cloud contains a lip feature database, which is stored in memory 1155 or the cloud. After activating the lip (hand) recognition module 600, the AI computing device 102 analyzes the user's speech (sign language) to determine the user's intended meaning. This helps the mute people express their meaning or facilitate users in situations where speech is difficult. Lip shape analysis can be trained using the generative model described above, collecting a large number of lip shape features to generate training results.

In one embodiment, a health model 500A, in conjunction with a facial health model, can be configured in the memory of a mirror, display, smart glasses 300, AI phones 102a, and AI tablets 102b to detect signs of disease. The human face is a unique identifier of a person, providing information such as age, mood, and health. The face is closely related to health. By observing facial features, such as the eyes and skin, one can initially infer whether there are health problems, which is crucial for timely treatment and improvement of symptoms. A healthy model 500A uses the Dlib library for face detection and the Vision Transformer model for training. This model is an image-based deep learning model based on the multi-head self-attention mechanism.

The self-attention mechanism improves model training speed and its scalability is widely used in the field of computer vision. It uses the Vision Transformer model to identify healthy and diseased faces. The public dataset used for training the model comes from images collected from search engines such as Google and Microsoft Bing. For example, Jiaqi Qiang et al. (2022) provides a comprehensive review of facial recognition applications for disease diagnosis, integrating different deep learning models and disease-related facial features. See Jiaqi Qiang, Danning Wu, Hanze Du, Huijuan Zhu, Shi Chen, and Hui Pan, "Review on Facial-Recognition-Based Applications in Disease Diagnosis," MDPI, https://www.mdpi.com/2306-5354/9/7/273, July 2022 (accessed Oct. 2023).

In another embodiment, referring to FIG. 4, most of the devices that are identical to those in FIG. 3 are not described in detail. The vehicle 102c has all the features described above in FIG. 1 to FIG. 3. In the embodiment of the vehicle 102c, the vehicle 102c further includes a security mechanism 1540. Because long-distance communication or cloud connectivity may access the public domain and expose users to unexpected risks, and because currently, most vehicles lack security mechanisms, the vehicle 102c of the present invention includes the security mechanism 1540. This security mechanism 1540 can be hardware or software (stored in memory) that can be activated and operated based on instructions from the processor 1000. The security mechanism 1540 includes a firewall, an antivirus software or any combination thereof. The firewall monitors all packets and identifies content that violates specific rules, preventing the rapid spread of computer worms and Trojans. In addition to traditional firewall functions, next-generation firewalls (NGFWs) also include inline deep packet inspection (DPI), intrusion prevention systems (IPS), application-layer detection and control, SSL/SSH inspection, website filtering, and QoS/bandwidth management, enabling these systems to handle complex and highly intelligent network attacks. The antivirus software is used to detect and remove computer viruses, worms, and Trojans. The antivirus software typically includes features such as real-time program monitoring and identification, malware scanning and removal, and automatic virus database updates. In another embodiment, the security mechanism 1540 utilizes a secure crypto-processor, a trusted platform module capable of independent key generation, encryption, and decryption. It has independent memory and runs its own micro-operating system, which can be used to store keys or signature data, providing encryption and security authentication for computing devices.

Referring to FIG. 4, most of the devices that are the same as those in FIG. 3 are not described in detail. The AI computing device 102 has an internal or external (wired or wireless) edge computing device 104A. Referring to FIG. 4, in one embodiment, the AI computing device 102 includes the edge computing device 104A which includes an AI model 1520 and an AI accelerator. The AI accelerator includes an AI processing unit 1510. The AI model 1520 includes a generative AI model stored in memory and coupled to the AI processor or AI processing unit 1510. The generative AI models are models that use machine learning algorithms to create new content. These models can generate new data based on given input data, such as text prompts or images. This new data is similar to the training data in some aspects, but is completely new content. The AI model 1520, the generative searching engine 305, and the AI voice assistant 400 are stored in memory and coupled to the AI processing unit 1510. In one embodiment, the edge computing device 104A is close to the data source, which can reduce information latency, improve computing efficiency, and reduce bandwidth usage. The AI processor or AI processing unit 1510 includes one or any combination of an NPU, a CPU, a GPU, and an ASIC. The NPU can quickly process large amounts of data. Compared to traditional CPUs and GPUs, the NPU generally has lower energy consumption and is suitable for mobile devices and embedded systems, optimized for specific AI and ML algorithms. The NPU quickly calculates the optimal path and dynamically adjust it based on real-time conditions to ensure safe and efficient driving.

The AI processing unit 1510 is selected from a graphics processing unit (GPU) that provides deep learning and AI operations, a tensor processing unit (TPU), which is acceleration hardware specifically for machine learning and deep learning and can process tensor operations more efficiently, and a field programmable gate array (FPGA), which is reconfigurable hardware that can be programmed to perform specific tasks. Application-specific integrated circuits (ASICs) are used to execute specific AI models to achieve maximum efficiency. The NPU helps accelerate AI model reasoning, improve performance and reduce energy consumption. The NPU improves reasoning speed and training speed through parallel computing and customized algorithms. The NPU quickly processes large amounts of data. Compared with traditional CPUs and GPUs, the NPU generally has lower energy consumption and is suitable for mobile devices and embedded systems, and is optimized for specific AI and ML algorithms. If applied to the vehicle 102c, the AI model is a trained artificial intelligence driving model. To process large amounts of data, the AI accelerator is equipped with high-bandwidth memory (not shown) to ensure fast data transmission. In one embodiment, the AI processing unit 1510 processes sensor data and can analyze the data to optimize driving strategies through the AI model 1520. In one embodiment, the above-mentioned vehicle can include unmanned aerial vehicles, land vehicles, and water vehicles.

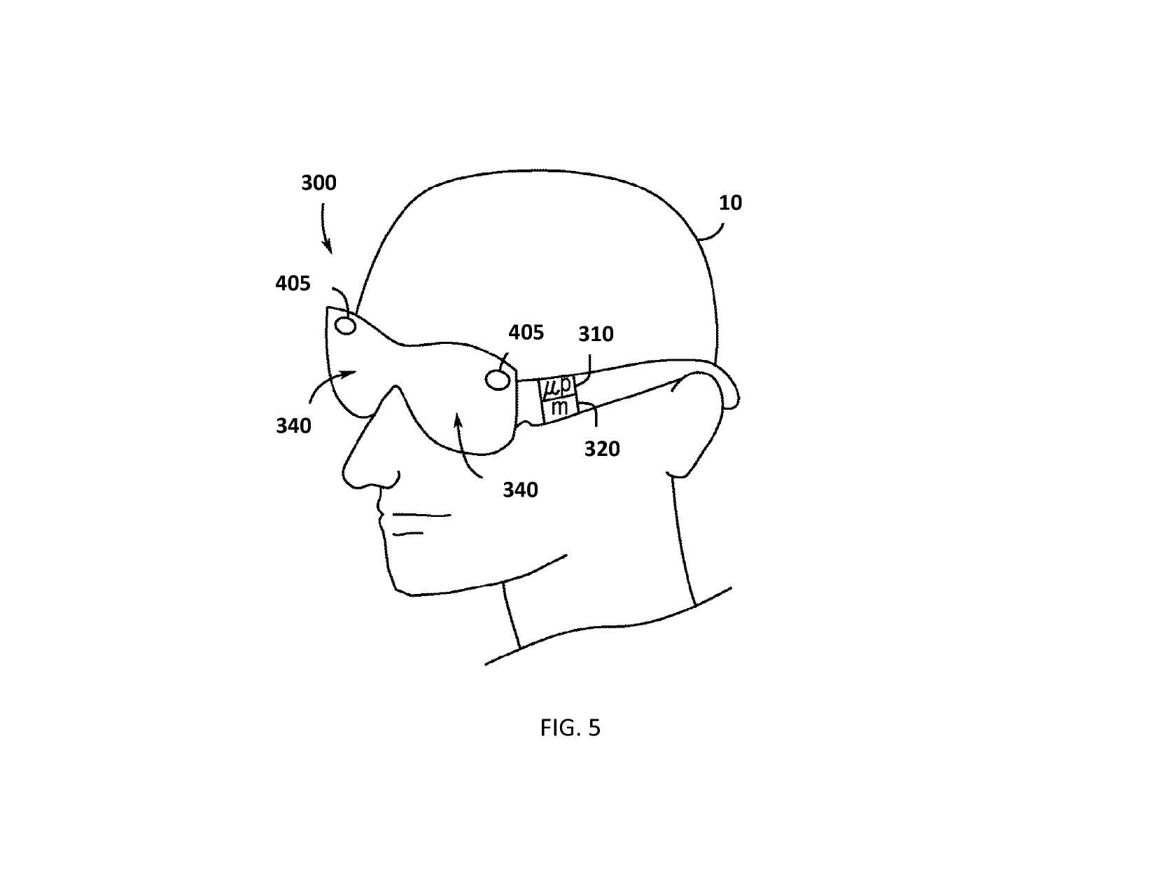

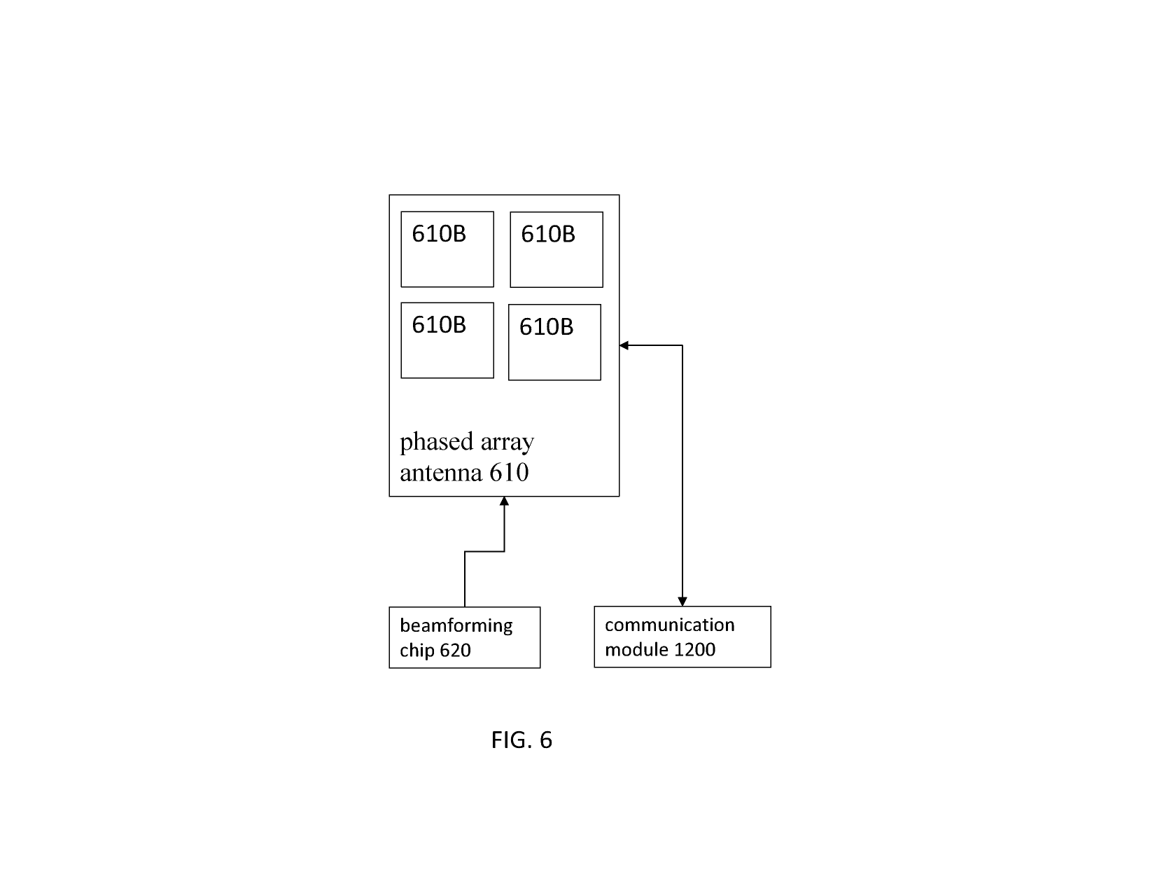

The present invention is also advantageously integrated with smart glasses 300. Please refer to FIGS. 4A and 5. FIG. 4A shows a functional block diagram of an embodiment of the present invention, which may also include most of the devices or components shown in FIG. 4. In this embodiment, the head-mounted device or smart glasses 300 includes a processor 310, a memory 320, a wireless communication module 330, a display 340, an inertial sensor (IMU) 360, and a GPS 365. Positioning can be performed independently using the GPS 365, or in conjunction with the inertial sensor 360, Wi-Fi, and other sensors to achieve precise positioning through algorithms. As shown in the figures, the controller 370 and the virtual reality (or augmented reality) generation module 380 are coupled to the processor 310. The memory 320, wireless communication module 330, display 340, inertial sensor 360, and virtual reality (or augmented reality) generation module 380 are coupled to the processor 310. In this embodiment, the head-mounted device or smart glasses 300 generates virtual images through the virtual reality (or augmented reality) generation module 380, which can overlap the real or virtual images. In one embodiment, the head-mounted device or smart glasses 300 has a touch-enabled controller 370 and buttons (not shown) to facilitate switching or inputting commands at any time. The inertial sensor 360 can be used to detect body movement, swaying, or head shaking, and other body motions, gestures, or postures, for image stabilization and interactive operations. The inertial sensor 360 can be, for example, a local positioning sensor, a gyroscope, an accelerometer, a magnetometer, or any combination thereof. The accelerometers include multi-axis accelerometers, such as 3-, 6-, or 9-axis accelerometers. The edge computing device 104A in FIG. 4 can be built into or externally connected to the head-mounted device or smart glasses 300. The head-mounted device or smart glasses 300 can include the AI model 1520, the generative searching engine 305, the AI voice assistant 400 or the combination thereof.

The head-mounted device or smart glasses 300 includes an eye detection light source 350 for detecting eye (or eye) movement and inputting the feedback signal into a processor to determine a defined corresponding signal. The eye detection light source 350 may be an infrared light source, and outputs a control signal based on the user's eye movement. The head-mounted device or smart glasses 300 can generate a virtual or augmented environment. The processor 310 of the head-mounted device or smart glasses 300 is electrically coupled to the controller 370. In one embodiment, the controller 370 includes a gravity sensor or an acceleration sensor to facilitate outputting direction commands to the processor 310. In one embodiment, the controller 370 may include a ring-shaped structure that can be attached to a finger or hand to facilitate manipulation. Alternatively, the controller 370 may be disposed on the side of the head-mounted device or smart glasses 300. The controller 370 is equipped with control devices, such as a power switch, setting buttons, and a touch screen. The controller 370 can also be controlled via a wired or wireless control signal, for example, to control its lateral tilt angle and tilt speed. The head-mounted device or smart glasses 300 includes the eye-detection light source 350 and the image sensor 405 for detecting eye movements. This can be used to issue commands through eye movements, and can also be used to detect eye features (such as the iris). The image sensor 405 receives the light reflection signal from the eye-detection light source 350 and then identifies the user's identity through recognition technology (such as iris recognition). Based on the recognition result, it triggers a command to allow or deny access. This can facilitate the user to access or enter the security control mechanism of the system, database, remote server, mobile phone or tablet through the head-mounted device or smart glasses 300. At least one identification sample (e.g., iris sample) is stored in the memory. This identification sample, used as a comparison target for identity recognition, can be stored in the smart glasses 300 or the AI computing device 102. The touch control technology of the controller 370 can utilize ultrasonic touch control technology. The image sensor 405 is used for external photography or for eye sensing.

The head-mounted device or smart glasses 300 includes a wireless communication module 330 to facilitate wired or wireless coupling with the AI computing device 102, thereby wirelessly receiving or transmitting commands. In this embodiment, the AI computing device 102 communicates with the cloud server, and the head-mounted device or smart glasses 300 communicates wirelessly with the AI computing device 102 via the wireless communication module 330. The virtual reality (or augmented reality) generation module 380 of the head-mounted device or smart glasses 300 processes data to generate virtual reality images, or the AI computing device 102 generates image content, which is then displayed by the head-mounted device or smart glasses 300. In one embodiment, the image sensor 405 of the head-mounted device or smart glasses 300 captures external images (and identifies objects, text, images, and videos). These images are then recognized by the smart glasses 300, or are transmitted to the tablet 102b or the smartphone 102a for recognition, or uploaded to the cloud for recognition by the generative AI server 104. In one embodiment, the smart glasses 300 connect to the generative large language model via the AI computing device 102 (e.g., 102b or 102a), as shown in FIGS. 1-4. As shown in FIG. 5, in this embodiment, the head-mounted device or smart glasses 300 is worn on the head of the user 10. The processor 310 of the smart glasses 300 can be a processing unit, an application-specific integrated circuit (ASIC), or other similar processor configurations. ASICs are integrated circuit chips tailored for specific applications or customer needs. Compared to general-purpose CPUs and GPUs, ASICs can perform specific tasks, such as AI reasoning, with higher performance, lower power consumption, and smaller size. In one embodiment, the display 340 may include a liquid crystal display, an organic light-emitting diode display, or a micro-light-emitting diode display. In one case, the image is guided by lenses or optical waveguides onto the glass, and is projected in front of the user's eyes, forming a virtual image superimposed on the real world. In another embodiment, the display 340 includes a transparent state to facilitate direct viewing of the real world and displayed images. It can also include photochromic materials to facilitate color changes between bright and dark spaces. Furthermore, the smart glasses 300 include an eye-gaze tracking device electrically coupled to the processor 310. The eye tracking refers to tracking eye movements by measuring the location of the eye's gaze point or the movement of the eye relative to the head. In one embodiment, the image sensor 405 is used to detect eye position. In another embodiment, the smart glasses 300 include an e-SIM card configuration and can connect to remote servers and external devices via a wireless communication device (module) 330 to access the large language model. The aforesaid emotion recognition module 500 can also be built into this head-mounted device or smart glasses 300. A gesture recognition utilizes the camera 405 or sensors to identify movements, while gestures are detected via the inertial sensor 360, such as nodding for confirmation. The eye tracking utilizes eye’s action to select or interact. The combination of image and IMU data can provide a more stable AR overlay effect.

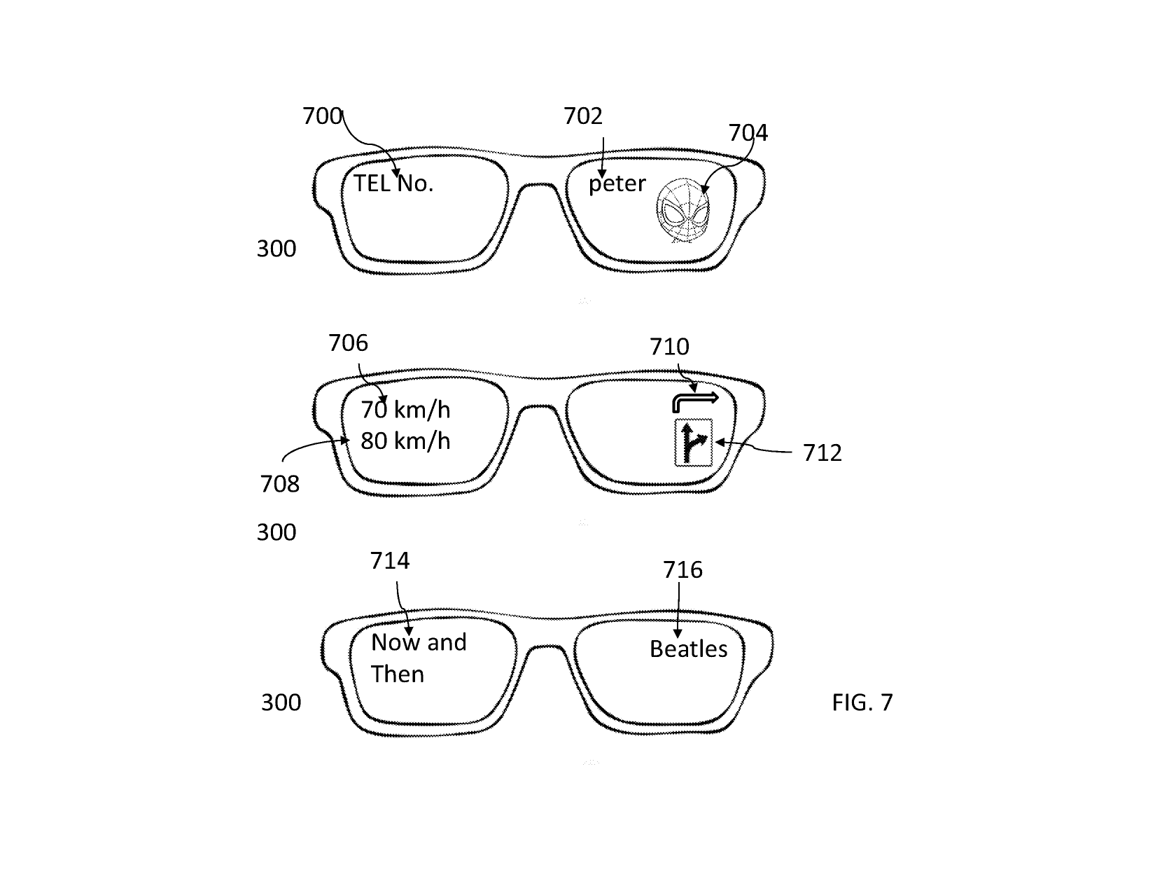

AI phones (smartphones) or tablets include built-in phone book (also known as address book, contacts) and instant messaging apps (such as LINE, WhatsApp, and Facebook Messenger). Typically, the phone book (address book, contacts) can be configured with contacts (names), phone numbers, and corresponding images (icons). The corresponding icons are typically configured with photos, images, or symbols. The present invention includes instant messaging service app to provide video conferencing, Internet phone calls (VoIP), and instant messaging. In one embodiment, the smart glasses 300 of the present invention are connected to an AI mobile phone (or smartphone) 102a. Upon receiving an incoming call, the caller ID or name is wirelessly transmitted to the smart glasses 300, and the caller information is displayed on the at least one glass of the smart glasses 300 (see FIG. 7). The caller information includes the phone number 700, the caller's name (or nickname) 702, and an icon corresponding to the name (caller's representative icon) 704 or any combination thereof. The smart glasses 300, when connected to the smartphone 102a, may display the caller’s name, ID, the caller icon, and the contact's representative icon or any combination thereof. In other words, the smart glasses 300 can be paired with the smartphone or tablet, and display incoming call information, such as the phone number 700, the name (or nickname) 702 of the caller, the caller's representative image 704 or the combination thereof on the glass or the display 340. The above connection can be achieved by pairing technology, which refers to the process of establishing a secure connection between two wireless devices. The most common is Bluetooth pairing. The process usually involves setting the device to discoverable mode, selecting the target device on the other device, and possibly verifying the connection through input. Successful pairing will exchange and store security information between the devices to facilitate easy connection or automatic reconnection in the future.

In one embodiment, the smart glasses 300 are connected to the vehicle 102c. The vehicle 102c transmits driving information to the smart glasses 3005 to display driving information, directions, or augmented reality, which can replace a heads-up display. The driving information includes vehicle speed 706, speed limit 708, (navigation) guidance 710, traffic signs 712 or any combination thereof. In another embodiment, the smart glasses 300 of the present invention are connected to the smartphone (or AI phone) 102a. When a music is played by the music app configurated in the smartphone (or AI phone) 102a, the streamed music information is transmitted to the smart glasses 300, where the music information is displayed on at least one glass of the smart glasses 300. The music information includes the song title 714, the artist 716, and the lyrics (not shown) or any combination thereof. In other words, the smart glasses 300 can be paired with the smartphone or tablet to display one or any combination of the song title 714, the artist 716, and the lyrics on the glass or display 340 of the smart glasses 300. In one embodiment, instant messages or images from instant messaging software can also be displayed on the smart glasses 300.

In one embodiment, when using low-orbit satellites for data transmission and positioning, the ground antenna's "field of view" (FOV) is approximately 100 degrees. The low-orbit satellite, such as Starlink, passes through the FOV for approximately four minutes. Therefore, every four minutes, the ground antenna must re-lock onto the next satellite that enters its field of view. A phased array antenna 610 must be configured in the generative (AI) computing device 102. The generative (AI) computing device 102 must include relevant chips and antennas. For example, a RF front-end module with a tile-based IC design can be coupled to an antenna array system or an IoT module. A (internal or external) beamforming chip 620 is coupled to the (internal or external) phased array antenna 610 to calibrate the beamforming antenna pattern, reduce antenna array pointing errors, and maintain maximum output power. The array antenna self-correction technology realizes beam steering to achieve tracking of low-orbit satellites. The high frequency range is, for example, 26.5-29.5 GHz / 37-40 GHz; the medium frequency range is, for example, 2.6-5.8 GHz / 3.3-6.7 GHz. The phased array antenna 610 is electrically coupled to the communication module 1200 to transmit or receive signals. The antenna substrate of the phased array antenna 610 can be divided into a plurality of sub-arrays (blocks) 610B, and each sub-array (block) 610B is composed of a plurality of antennas, such as aperture coupled patch antenna. For example, 4 sub-arrays (blocks) 610B, each sub-array (block) has 4x4 antennas, forming an 8x8 array antenna; more antennas are better, such as 128, 256, 512, or 1024. Each miniature antenna also has a multi-layer structure. The alternating peaks and troughs of the AC wave cause the electric field to alternate in direction, generating radial electromagnetic waves radiating outward from the patch. The intensity of these electromagnetic waves depends on the input voltage. The antenna consists of 36 to 1024 small antennas.

The electromagnetic waves emitted by each antenna are sinusoidal. The peaks or troughs of two waves in phase create constructive interference, increasing the amplitude of the resulting wave and narrowing the beam. Beamforming refers to using the principle of interference to form a powerful electromagnetic beam and transmit signals to devices hundreds of kilometers away. In addition to enabling communication with 550-kilometer low-orbit satellites, it is also possible to achieve point-to-point (generative (AI) computing device 102) transmission on the ground, eliminating the need for intermediate base stations. The waveform is formed into a beam perpendicular to the antenna plate. Because low-Earth orbit satellites, such as Starlink, travel through the field of view (FOV) at speeds of 27,000 kilometers per hour, tracking of these satellites cannot rely on antenna swing, but rather on phase control. Two sinusoidal waves of the same frequency can have a phase difference, caused by the different transmission times of the two sinusoidal waves. The phase difference is the angle between adjacent peaks of the two waves, and ranges from 0 to 359 degrees. Adjusting the phase difference allows the constructive interference beam to move from a vertical orientation to a left-right oscillation, such as +45 or -45 degrees. This phase difference results in different beam orientations.

The array antenna waveform utilizes phase differences to generate 3D wavefronts at different angles. While the antenna remains stationary, the wavefront formed by controlling the timing of each antenna's sinusoidal peaks can change direction as the satellite moves, creating a 100-degree field of view (FOV). Beamforming chips 620 act as phase shifters. Phased array antenna 610, coupled to communication module 1200, can also be used in 5G MIMO in mobile phones. A beamforming phased array uses subarrays 610B of phased array antenna 610, which are combined to form a complete array (e.g., 32, 64, 128, or 256 antennas, depending on system requirements). The greater the number of antennas, the narrower the half-power beam width (HPBW) of the resulting beam, and the greater the gain of the phased array antenna 610. The CPU handles beam steering and control instructions, while the FPGA implements the external data interface, responsible for communicating with other units and distributing and receiving various data, including clock information, command information, beam angles, and scheduling information.

The phased array antenna 610 is embedded in the vehicle's glass or mounted on the vehicle's roof or shell, forming a vehicle-mounted phased array antenna 610, such as a 1024-antenna, 28 GHz millimeter-wave phased antenna array. The phased array antenna 610 is constructed of low-temperature co-fired ceramic (LTCC) material and designed as a multilayer board based on antenna size and requirements to reduce inter-antenna coupling. In one embodiment, the phased array antenna 610, such as 32, 64, or 128 millimeter-wave antennas, can be mounted on the front or back of a mobile phone 102a, tablet 102b, laptop, or the back panel of a foldable phone. For example, the antenna can be placed on the outer surface, inner surface, or inside the back panel of a mobile phone. Radio frequency signals cannot penetrate metal, but can penetrate glass, plastic, and ceramic. Alternatively, a foldable, flip-out substrate can be used to support the phased array antenna 610, particularly if the foldable phone has a flip-out mechanism.

The size of the phased array antenna varies depending on the application scenario and can range from a few centimeters to several meters. The size of the phased array antenna is related to its operating frequency and the required beam coverage. Higher frequencies require smaller antennas, but more array elements may be required. Larger beam coverage requires larger antennas. Higher operating frequencies mean antennas can be relatively small, especially in millimeter-wave applications. To cover a wider angular range, larger antennas are required.

Increasing the number of array elements improves beam steering and gain. Different application scenarios have different requirements for antenna size. For example, antennas for mobile communications typically require smaller dimensions, while antennas for radar may require larger dimensions.

Referring to FIG. 3A, most of its components, functional blocks, and modules are similar to those of the embodiment of FIG. 3, the repeated parts or portions will be omitted. The embodiment of FIG. 3A includes a video generator 650, which can perform operations through the processor 1000. The video generator 650 can be a program, software, or APP. The video generator 650 is a tool that can convert photos into videos through an AI model, in other words, convert static photos into dynamic videos. Referring to FIG. 3B, the video generator 650 includes a template (sample) module 651, a material module 652, a keyword (prompt) word input interface 653, a camera movement special effects module 654, and an AI animation generation module 655. The template (sample) module 651 provides templates for various scenes, contents, and plots. After selection, a video with the selected template style is generated based on the photo through AI. The material module 652 provides users with the selection of backgrounds, scenes, building materials, textures, and other effects. The video generator 650 analyzes the image content and generates a video with the desired style. Alternatively, video keywords (prompts) can be entered through the keyword (prompt word) input interface 653 to facilitate the generation of a stylish video. It converts static images into animated videos, adding elements such as scenes, characters, and music, and customizing camera movements and special effects, selecting functional modules based on needs. In one embodiment, the video generator 650 is trained using a convolutional neural network (CNN) and a generative adversarial network (GAN). The CNN is responsible for extracting important features from the input image, while the GAN is responsible for generating natural and high-quality images, further optimizing the effect through feature extraction.

In one embodiment, the video generator 650 communicates with an AI-driven video generation model. The AI-driven video generation model is based on a generative video model and integrates technologies such as Generative Query Network (GQN), DVD-GAN, Imagen-Video, Phenaki, WALT, and Lumiere. This model can enhance realism, improve the simulation of real-world physics, and produce realistic and diverse video outputs. The AI-driven video generation model can be deployed on the generative device 102, the edge computing device 104A, or the cloud server 104, and transmit instructions, requests, and signals via the aforesaid wireless communication technologies. In one embodiment, the video generation process includes executing the following steps via the processor 1000: a large amount of public photo and video data is inputted by the data collection module as training data. The training module, through multiple iterations of training, enables the AI-driven video generation model (or video generator 650) to learn and simulate the characteristics and expressions of people and animals in different photo scenes; the target image, including the target photo and template (or keyword, prompt word), is input to the trained video generator 650, which performs preliminary processing on the input target image for automatic recognition, feature extraction, and image synthesis to simulate the movement of the person, object, or animal in the target photo to form a dynamic video; the output module is used to output the final optimized video. In one embodiment, the above steps include detail adjustments, such as edge correction, light and shadow adjustment, and color balance optimization. All the above modules and units are stored in a storage device or memory and can be calculated and accessed by the processor.

In the video generator 650, the photo conversion and entering prompt word or keyword (optional) is set. For example, a text description to guide the video generator 650 is entered to generate a video with a specific AI effect. A template (optional) is selected. The video generator 650 provides templates or samples to choose from, or allows the user to set the video length and resolution. The above steps are optional or switched. Then, click the “Generate” button and wait for the video generator 650 to complete the video generation. After the video is generated, continue editing or optimizing the video is optional. In one embodiment, in conjunction with a cloud-based generative model or edge computing device, it helps the video generator 650 quickly transform photos into vivid videos. The video generator 650 analyzes the scene, characters, and composition in the photo and, based on specific instructions or templates, automatically "imagines" coherent dynamic images, such as character movement, background extensions, and camera movements, making the image visually impactful and emotionally expressive.

The above objectives can be achieved through the trained AI-driven video generation model. The video generator 650 includes or be coupled to the AI-driven video generation model to generate an AI video function. The video generator 650 can capture and sort out the features of a static photo to create a dynamic video. In the step of specifying or setting a specific style photo, the desired visual style is input, such as "running on the beach" or "twirling in the wind". The video generator 650, which has been trained by AI video generation, will extend the static image into a dynamic clip with a sense of story, creating a sense of action or emotional. By inputting a command to apply a template or sample, such as a template from the video generator 650 or social media (e.g., Instagram or YouTube), allowing the video generator 650 connects to the social media. The video generator 650 then extracts the specific characteristics of the video from the designated social media and then applies realistic expressions and movements to the still portrait, as well as stylized characters. A wide variety of templates or templates are available: specify a photo, select a style, and the video generator 650 automatically generates an animated video using AI. The video generator 650 features built-in AI motion tracking, object detection, and text-to-speech capabilities, simplifying complex editing tasks and facilitating rapid video production while maintaining creative freedom and superior results. Furthermore, the video generator 650 includes an AI animation generation module 655, which can transform photos into animated characters. Combining image-to-video and animation generation capabilities allows for the creation of customized animated videos. These features, devices, and components can also be implemented in the head-mounted device or smart glasses 300.

The embodiments shown in the figures above can be used interchangeably, and some or all modules, devices, and components can be integrated. Processors include various processing units, application-specific integrated circuits, and the like. Image sensors or image capture devices include various types of photographic devices and camera devices. A module is a component composed of several basic functions and can be used to form a fully functional system, device, or program. In the field of programming and software, a module is a set of interconnected software organizations, typically consisting of programs and data structures. Processors and processing units are generally synonymous, and communication devices and communication modules are generally synonymous. The foregoing description is intended to illustrate the preferred embodiments of the present invention. Those skilled in the art should understand that the description is provided to illustrate the present invention and is not intended to limit the scope of the claims. The scope of present invention shall be determined by the appended claims and their equivalents. Any modifications or improvements made by those skilled in the art without departing from the spirit or scope of this patent shall be deemed equivalent changes or designs accomplished within the spirit of the present invention and shall be included in the following claims.

What is claimed is:

1. A smart glasses comprising:
an image capturing device configurated in said smart glasses;
an AI voice assistant stored in a memory of said smart glasses to provide an assistant;
an edge computing device, configured in said smart glasses, coupled to said AI voice assistant to provide an AI analysis; wherein an image captured by said image capturing device or a result of said AI analysis is displayed on said smart glasses.

2. The smart glasses of claim 1, wherein said AI voice assistant automatically adjusts a setting based on a user preference.

3. The smart glasses of claim 1, wherein an external controller is provided to wirelessly couple to said smart glasses to control a function of said smart glasses.

4. The smart glasses of claim 1, wherein an emotion recognition module or a facial health model is provided in said memory, said emotion recognition module being used to extract an emotion feature, said facial health model being used to detect signs of disease; wherein said emotion feature or said detected signs is captured by said image capturing device.

5. The smart glasses of claim 1, wherein a sensor disposed on said smart glasses to sense a surrounding environment or a posture or gesture.

6. The smart glasses of claim 1, wherein said smart glasses includes an eye detecting device and an identity recognition template.

7. The smart glasses of claim 1, wherein said edge computing device includes an AI model, and an AI processing unit.

8. The smart glasses of claim 1, wherein said smart glasses includes a waveguide.

9. The smart glasses of claim 1, wherein said smart glasses couples to an AI computing device, wherein said smart glasses display an information from said AI computing device, said information including a song title, an artist, a lyric, a phone numbers, a contact name, a contact image, an instant message, a sticker or any combination thereof.

10. The smart glasses of claim 1, wherein said smart glasses couples to a vehicle, wherein said smart glasses display an information from said vehicle, said information including a driving information, a direction, a traffic sign, augmented reality or any combination thereof.

11. A smart glasses comprising:
an image capturing device configurated in said smart glasses;
an AI voice assistant stored in a memory of said smart glasses to provide an assistant;
a communication device configurated in said smart glasses, wherein said communication device is wirelessly coupled to an external AI computing device or AI server to access a generative AI model; wherein an image captured by said image capturing device or a result from said generative AI model is displayed on said smart glasses.

12. The smart glasses of claim 11, wherein an external controller is provided to wirelessly couple to said smart glasses to control a function of said smart glasses.

13. The smart glasses of claim 11, wherein an emotion recognition module or a facial health model is in said memory, said emotion recognition module being used to extract an emotion feature, said facial health model being used to detect signs of disease; wherein said emotion feature or said detected signs is captured by said image capturing device.

14. The smart glasses of claim 11, wherein said smart glasses includes a sensor configured in said smart glasses, said sensor including an inertial sensor, a GPS, a magnetometer or the combination thereof.

15. The smart glasses of claim 11, wherein said smart glasses includes an eye detecting device and an identity recognition template.

16. The smart glasses of claim 11, wherein said smart glasses includes a waveguide.

17. The smart glasses of claim 11, wherein said smart glasses couples to an AI computing device, wherein said smart glasses display an information from said AI computing device, said information including a song title, an artist, a lyric, a phone numbers, a contact name, a contact image, an instant message, a sticker or any combination thereof.

18. The smart glasses of claim 11, wherein said smart glasses couples to a vehicle, wherein said smart glasses display an information from said vehicle, said information including a driving information, a direction, a traffic sign, augmented reality or any combination thereof.

19. The smart glasses of claim 11, wherein said AI voice assistant automatically adjusts a setting based on a user preference.

20. The smart glasses of claim 11, wherein a sensor disposed on said smart glasses to sense a surrounding environment, a posture or gesture.
